(19) United States
(12) Patent Application Publication
(10) Pub. No.: US 2016/0182991 A1
(43) Pub. Date: Jun. 23, 2016

(54) Wireless earbuds without separate audio source

(71) Applicants: Joseph John Zakzeski, Carson City, NV (US); Isa Alexandra Queiroz da Fonseca, Cacem (PT)

(72) Inventors: Joseph John Zakzeski, Carson City, NV (US); Isa Alexandra Queiroz da Fonseca, Cacem (PT)

(73) Assignee: Joseph John Zakzeski, Carson City, NV (US)

(21) Appl. No.: 14/756,838

(22) Filed: Sep. 7, 2014

(51) Int. Cl. H04R 1/10

(52) U.S. Cl. CPC H04R 1/105; H04R 1/1091; H04R 2201/109; H04R 2460/01

(57) ABSTRACT

State-of-the-art wireless earbuds provide audio from a common audio player, such as a smart phone or other music player. With the disclosed invention, a user may enjoy audio from wireless earbuds without the need for a separate remote audio player. A user or multiple users may thereby enjoy audio in one or both ears without the need to carry a separate audio player. The individual wireless earbuds may each receive the audio signal from the common audio source and then produce audio accordingly. Each earbud may produce left stereo or right stereo audio or both left and right stereo simultaneously. The individual wireless earbuds may alternatively have a master-slave configuration where a master earbud plays audio and transmits a wireless signal based on the wireless audio signal to the slave earbud. The slave earbud then plays audio based on the wireless signal from the master earbud.

### BACKGROUND

Embodiments of the invention relate to wireless earbuds. More particularly, embodiments relate to using wireless earbuds to produce audio without the need for a separate audio source.

Users of audio sources, such as personal audio and communications devices, typically use some form of a headset or earbud in order to maintain privacy and/or to avoid annoying bystanders. These audio sources are often used during various forms of physical exercise. Initially, earbuds and headsets required a wired connection to the audio source. However, earbuds and headsets have advanced so that the ultimate connection to the audio source may be wireless. Users often prefer a wireless earbud because there is little structure to wear, and, in some cases, the earbud may be nearly unnoticeable while being worn. Examples of such earbuds can be found in patents to Zellner (U.S. Pat. No. 8,180,078 B2), DeKalb (U.S. Pat. No. 6,810,987 B1), Oka (Us2004/0051788 A1), Chiloyan (US 2007/0147629 A1, and WO-2006064170.

While wireless earbuds are becoming commonplace as users desire hand free operation and no clutter from wires, there are drawbacks. For example, users are required to carry a separate audio source, such as a smart phone or music player, in order to listen to audio, which may be inconvenient especially for runners, swimmers, or those performing physical exercise.

### SUMMARY

Embodiments address issues such as these and others by wireless earbuds that may provide audio without the need for a separate audio source. Thus, the master earbud may have only a wireless connection to the second earbud so that the user may experience audio in each ear while having an entirely wireless configuration between the multiple earbuds without the need for the common audio source while playing audio.

Embodiments provide an earbud system that includes a first earbud which includes a first speaker and a first wireless receiver that is in wireless communication with a second wireless earbud. The first wireless contains memory, stores an audio signal, and transmits a signal, and the received audio signal is provided to the first speaker to produce sound from the first earbud. An optional second earbud includes a second speaker and a second wireless receiver that is in wireless communication with the first wireless receiver. The second wireless receiver receives the audio signal from the first wireless earbud, and the received audio signal is provided to the second speaker to produce sound from the second earbud.

Embodiments provide an earbud system that includes a first earbud that transmits a wireless audio signal, and that outputs audio corresponding to the signal stored in the device memory via a first speaker. A second earbud is optionally included and receives the second wireless audio signal from the first earbud and outputs audio corresponding to the second audio signal via a second speaker.

Embodiments provide an earbud that includes a housing that fits into an ear. The earbud further includes a speaker that plays audio based on a stored signal. The earbud also includes a wireless transmitter that sends a second wireless signal to a second device different than the audio source.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 depicts one example of an earbud system using at least one earbud in ear 1 without a separate audio source according the various embodiments.

FIG. 2 depicts another example of an earbud system using at least one earbud in ear 2 without a separate audio source according the various embodiments.

FIG. 3 depicts another example of an earbud system using at least one earbud and optionally an additional earbud 2 without a separate audio source according the various embodiments.

FIG. 4 depicts an embodiment of the earbud system in which the earbud is supported by an earbud hanger, in which the earbud may be inside or outside of the ear.

FIG. 5 depicts an example of the components of the earbud system according to various embodiments.

### DETAILED DESCRIPTION

Embodiments provide for a system of earbuds where each individual earbud is wireless, and each earbud plays audio concurrently with the other based without the need for an audio signal from a separate audio source. Accordingly, users can enjoy audio from the earbud or earbuds without a separate audio source.

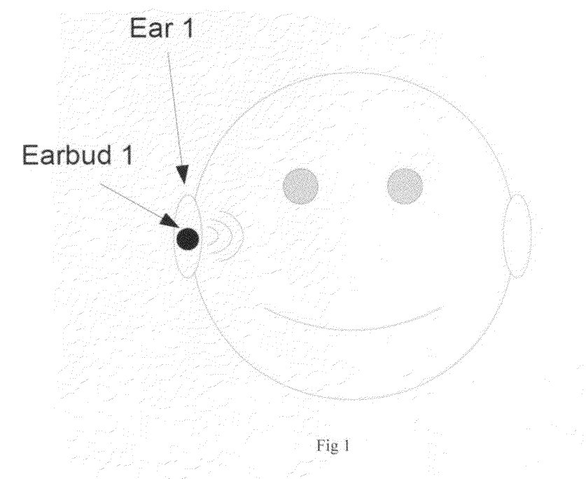

FIG. 1 shows one example of an earbud system. In this example, a first wireless earbud 1 is being worn on an ear 1. Also in this example, a first wireless earbud 1 generates audio without a wireless audio signal from a separate audio source such as a personal digital music player, device 1 and/or a mobile communications device, device 2. While the wireless earbud 1 is shown being worn on or in the ear, it will be appreciated that embodiments of the wireless earbud 1 may also be worn in proximity to the ear 1, rather than directly on or in the ear 1 such as where the sound is projected into a nearby ear 1 or sound is communicated through surrounding bone to the ear 1, at the discretion of the user.

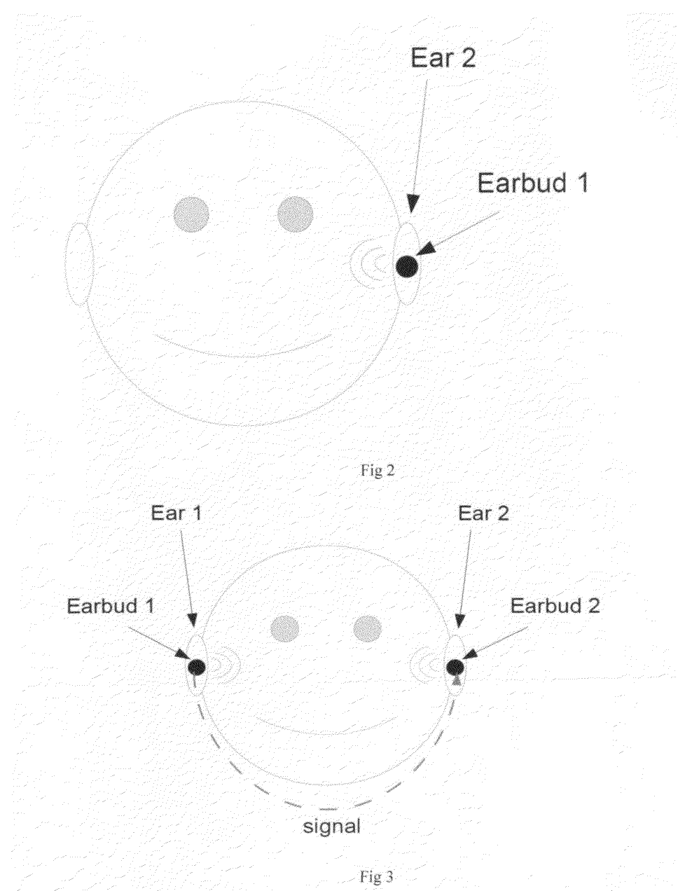

FIG. 2 shows one example of an earbud system. In this example, a first wireless earbud 1 is being worn on an ear 2. Also in this example, a first wireless earbud 1 generates audio without a wireless audio signal from a separate audio source such as a separate personal digital music player and/or a mobile communications device. While the wireless earbud 1 is shown being worn on or in the ear, it will be appreciated that embodiments of the wireless earbud 1 may also be worn in proximity to the ear 1, rather than directly on or in the ear 1 such as where the sound is projected into a nearby ear 1 or sound is communicated through surrounding bone to the ear 2 at the discretion of the user.

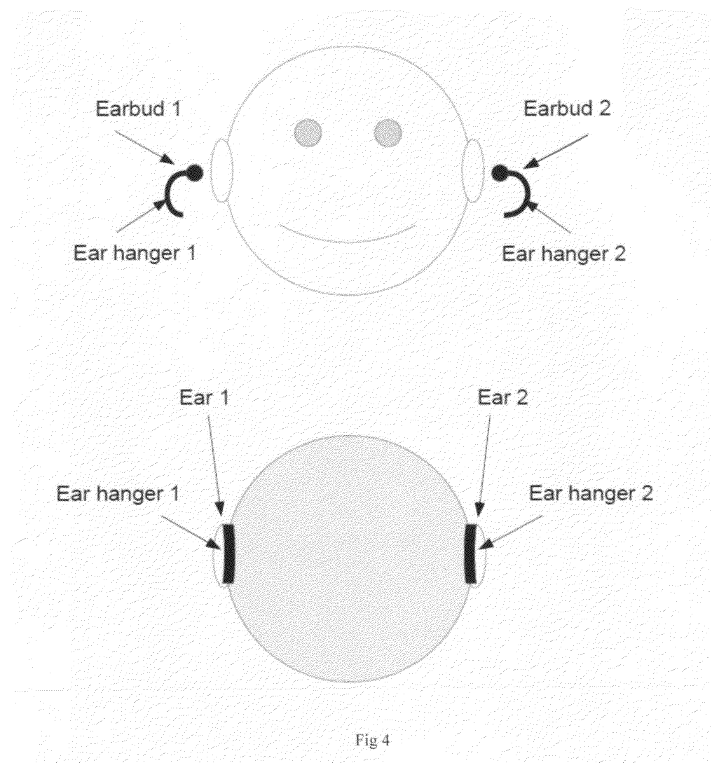

FIG. 3 shows one example of an earbud system. In this example, a first wireless earbud 1 is being worn on an ear 1. Ear 1 may be the left ear or the right ear. In this example, a second earbud 2 is worn in an ear 2, which is the left ear if wireless earbud 1 services the right ear or the right ear if wireless earbud 1 services the left ear. Also in this example, a first wireless earbud 1 generates audio without a wireless audio signal from a separate audio source such as a personal digital music player and/or a mobile communications device, using built-in memory. Also in this example, a master wireless earbud 1 transmits an audio signal to a second wireless earbud 2, which receives the signal and produces audio. While the wireless earbud 1 and/or wireless earbud 2 are shown being worn on or in the ear, it will be appreciated that embodiments of the wireless earbud 1 and/or wireless earbud 2 may also be worn in proximity to the ear 1 and the ear 2, rather than directly on or in the ear 1 and ear 2 such as where the sound is projected into a nearby ear 1 and ear 2 or sound is communicated through surrounding bone to the ear 1 and ear 2, at the discretion of the user. The second wireless earbud 2 receives an audio signal that is sent by the first wireless earbud 1. Thus, the first wireless earbud 1 acts as a master, while the second wireless earbud 2 acts as a slave.

In one embodiment, the wireless earbud 1 acts as a master, while a second wireless earbud 2 acts as a slave. Multiple additional earbuds, for example, a third and a fourth earbud, may also serve as slave. In this way, two or more users can simultaneously listen to the same audio signal transmitted by wireless earbud 1.

As another example, the wireless earbud 1 and/or wireless earbud 2 may maintain a communication session, such as via a Bluetooth®, Advanced Audio Distribution Profile (A2DP) or similar wireless digital protocol known to those skilled in the art. The wireless earbud 1 and wireless earbud 2 may be capable of transferring data to or from internal memory and a separate audio source such as a personal digital music player and/or a mobile communications device.

According to one or more illustrative embodiments, in addition to wireless earbud 1 and/or wireless earbud 2 receiving audio signals, at least one wireless earbud 1 also sends an audio signal. In the example shown, the earbud 1 sends an audio signal to wireless earbud 2. The earbud 1 or earbud 2 may include a microphone so that the user may record an audio signal such as for voice control or audio reminders.

In one embodiment, the second earbud 2 could include a microphone and transmitter instead of the first earbud 1.

The wireless earbud 1 may correspond to the left (L) channel of stereo audio or to the right (R) channel of stereo audio or may play both stereo signals simultaneously. Similarly, the wireless earbud 2 may correspond to the left (L) channel of stereo audio or to the right (R) channel of stereo audio or may play both stereo signals simultaneously.

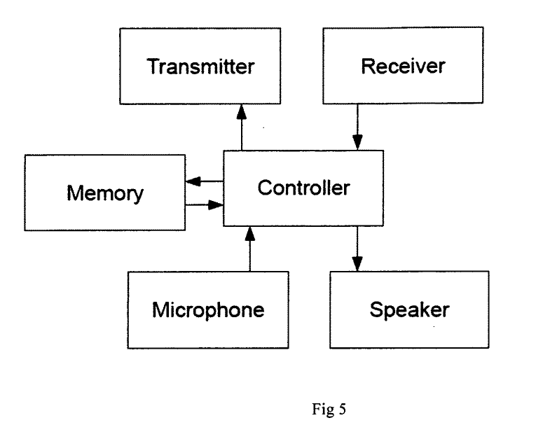

FIG. 4 shows another example of earbuds. These earbuds have a form factor that allows a main body earbud 1 or earbud 2 to reside externally but adjacent to the ear of the user. These earbuds may be secured in place through an ear hanger 1 or ear hanger 2 to rest on the ear so that the main body earbud 1 or earbud 2 is suspended from the ear and is positioned near the ear canal.

According to some illustrative embodiments, the ear hangers 1, 2 may pivot about a pivot center so that a earbud 1 or earbud 2 may be used for either a left ear or a right ear.

In the examples shown, the earbud 1 and earbud 2 may be used in either the right ear or the left ear. In cases in which a single earbud is in use, the single earbud may emit the right stereo, left stereo, or both signals simultaneously. Similarly, in cases in which more than one earbud is in use, each individual earbud may emit the left stereo signal, the right stereo signal, or both simultaneously. For example, the master earbud may emit the left audio signal while a slave earbud emits the right stereo signal. In another embodiment, the master earbud may emit the right audio signal while a slave earbud emits the left audio signal. In yet another embodiment, both earbuds may emit both the left and the right stereo signal simultaneously.

FIG. 5 shows an example of components of an earbud 1 or an earbud 2 according to various embodiments. This earbud 1 or earbud 2 may correspond to either of the form factors discussed above in relation to FIG. 1, 2, 3 or 4 as well as other form factors. The earbud includes a controller that performs logical operations to receive audio signals, transmit audio signals, and provide audio playback to the user. The controller may be of various forms such as a general purpose programmable processor, an application specific processor, hard wired digital logic, and various combinations thereof.

The controller where it may store programming or digital logic to be self-executed, is an example of a computer readable medium which store instructions that when performed implement various logical operations. Such computer readable media may include various storage media including electronic, magnetic, and optical storage. Computer readable media may also include communications media, such as wired and wireless connections used to transfer the instructions or send and receive other data messages.

The controller communicates with various other components. The controller may communicate with a wireless receiver that may receive audio from an external device that sends information such as an audio signal to the earbud.

According to illustrative embodiments, another component that may be present is a wireless transceiver. This transceiver may be used to wirelessly communicate bi-directionally with an external device such as separate audio source such as a personal digital music player and/or a mobile communications device. For example, the audio source may utilize a digital protocol such as the Bluetooth® protocol and may require a handshake and/or acknowledgement of communication attempts in order to receive the audio signal. In that case, the transceiver may receive data packets from and also send return data packets to the audio source.

The controller may obtain audio via the transceiver by a microphone for the purposes of voice control. This microphone receives the spoken audio from the user. This microphone may be of various types, such as a first type to have a narrow reception cone to attempt to receive only spoken audio from the user or a second type to have a broad reception cone to attempt to also receive background audio.

The controller provides audio playback to the user by channeling audio signals received via the receiver or transceiver to a speaker system. The speaker system includes a transducer and any necessary amplification to produce audio at levels adequate for the user to hear when the earbud is mounted on the ear of the user.

For embodiments where the earbud 1 is a master that provides the audio signals to a slave earbud 2, either a transmitter such as that of the transceiver or a dedicated transmitter may be included. The controller may provide the audio signal to be received by the slave earbud to the transmitter which then transmits a wireless signal that is received by the slave earbud. As discussed above, this wireless signal to the slave earbud may be of various forms, such as an analog signal or a digital signal corresponding to a particular protocol.

The controller may employ signal processing to the received audio signal to separate the audio signal into the various channels it may include. The controller may then send the appropriate channels of the audio signal to the appropriate components. For example, if the earbud 1 is set to play all received channels, then all channels are provided to the speaker system in earbud 1. If the earbud 1 is set to play the right stereo signal, then the controller may provide the right stereo signal to the speaker system 1 while providing the left stereo signal to the transmitter for sending to the slave earbud for playback of the left stereo signal.

The wireless earbud 1 and/or wireless earbud 2 may optionally include a variety of enhanced functions beyond audio playback. The wireless earbud 1 or wireless earbud 2 may contain biosensors such as those used to monitor heart rate. In one embodiment a user could use the device to measure a heart rate while exercising or at rest. The wireless earbud 1 and/or wireless earbud 2 may contain sensors to measure temperature, blood sugar levels, blood pressure, and other biologically relevant information.

In addition, wireless earbud 1 and/or wireless earbud 2 may contain additional components. For example, a geonavigational position system (GPS) tracker could be included in wireless earbud 1 or wireless earbud 2. For example, the GPS tracker could track the position or path traveled by a user. In another embodiement, the GPS tracker could be used in locating a lost, missing or stolen wireless earbud device. In another embodiment, the wireless earbud 1 and/or wireless earbud 2 may contain an accelerometer or other device used to analyze the motion of the wireless earbud 1 and/or wireless earbud 2 to measure the physical mobility of the user.

In another embodiment, the wireless earbud 1 and/or wireless earbud 2 may contain noise canceling or hearing aid devices in order to reduce the amount of background noise.

In another embodiment, the wireless earbud 1 and/or wireless earbud 2 may contain sound amplification for the use as a hearing aid.

In addition, the wireless earbud 1 and/or wireless earbud 2 may contain voice recognition components. Thus the wireless earbud 1 and/or wireless earbud 2 may be able to recognize voice spoken commands and respond to the commands accordingly. For example, a user may indicate a desire to adjust speaker volume by saying a command, and the wireless earbud 1 and/or wireless earbud 2 may recognize said command and respond accordingly.

The wireless earbud 1 and/or wireless earbud 2 may contain additional components commonly found in other computing devices, such as tracking the current date and time, provide various alarms and the ability to store calendar events and data such as to-do lists. The wireless earbud 1 and/or wireless earbud 2 may be able to receive voice commands and provide voice reminders and other tasks as typically found in personal digital assistants. The memory contained in wireless earbud 1 and/or wireless earbud 2 could therefore be used to generate reminder lists and other audio for subsequent playback.

In one embodiment, these additional features are used simultaneously by the user and in combination with or without audio playback.

While embodiments have been particularly shown and described, it will be understood by those skilled in the art that various other changes in the form and details may be made therein without departing from the spirit and scope of the invention.

What is claimed is:

1. An earbud system, comprising: a first earbud that comprises a first speaker and a first transmitter that is capable of generating an audio signal without being in wired or wireless communication with a separate audio source; and optionally a second earbud that comprises a second speaker and a second wireless receiver that is in wireless communication with the first wireless earbud the received audio signal being provided to the second speaker to produce sound from the second earbud.

2. The earbud system of claim 1, wherein the earbud can be used individually without a second earbud, or in combination with one more additional wireless earbud devices.

3. The earbud system of claim 1, wherein the audio signal sent by the first earbud is capable of being sent as stereo right, stereo left, or both stereo right and stereo left and wherein the audio signal received by the second earbud is capable of receiving these audio inputs.

4. The earbud system of claim 1, wherein the audio signal is received by the second wireless receiver as a digital signal following a first protocol and wherein the first and second wireless receivers are responsive to the first protocol to deliver the audio signal to the first and second speakers.

5. The earbud system of claim 1, wherein the first earbud is with or without external ear support that wraps around the outer ear.

6. The earbud system of claim 1, wherein the first earbud optionally comprises at least one of a recorder module in electrical communication with the first receiver for recording audio signals, a noise cancellation circuit in electrical communication with the first receiver, and a voice recognition capability.

7. The earbud system of claim 1, where at least the first earbud has a transmitter that transmits signals and wherein the signals transmitted by the first earbud are received by the second earbud.

8. The earbud system of claim 7, wherein the signals instruct the second earbud regarding outputting of the audio signal received from the audio source.

9. An earbud system, comprising: a first earbud that transmits a wireless audio signal, and that outputs audio corresponding to the first audio signal via a first speaker; and a second earbud that receives the second wireless audio signal from the first earbud and that outputs audio corresponding to the second audio signal via a second speaker.

10. The earbud system of claim 9, wherein the second wireless audio signal is a duplicate of the first wireless audio signal.

11. The earbud system of claim 9, wherein the first wireless audio signal includes left and right stereo signals of audio, wherein the first earbud outputs audio via the first speaker for at least one of the signals of audio, wherein the second wireless audio signal includes either the left or right stereo signal, and wherein the second earbud outputs audio via the second speaker corresponding to at least one channel of audio from the subset.

12. The earbud system of claim 11, further comprising a microphone that produces an electrical signal, wherein the wireless transmitter sends a second wireless signal to a communications device, the second wireless signal being based on the electrical signal.

13. The earbud system of claim 11, wherein the wireless earbud contains biosensors capable of recording blood pressure, blood sugar levels, heart rate and temperature for review by a physician or doctor.

14. The earbud system of claim 11, wherein the wireless earbud contains global positional system capability.
